(19) United States
(12) Patent Application Publication
(10) Pub. No.: US 2025/0348205 A1
(43) Pub. Date: Nov. 13, 2025

(54) ARBITRATION OF TOUCH INPUT BASED ON DEVICE ORIENTATION

(71) Applicant: Google LLC, Mountain View, CA (US)

(72) Inventors: Ishan Chatterjee, Seattle, WA (US); Karan Ahuja, Seattle, WA (US); Eric Jordan Gonzalez, Seattle, WA (US)

(21) Appl. No.: 18/660,587

(22) Filed: May 10, 2024

(51) Int. Cl. G06F 3/0488; G06F 3/01; G06F 3/0346

(52) U.S. Cl. CPC G06F 3/0488; G06F 3/013; G06F 3/0346

(57) ABSTRACT

According to at least one implementation, a method includes identifying an orientation of a first device relative to a second device and determining whether the orientation satisfies at least one criterion. In response to the orientation satisfying the at least one criterion, the method further includes receiving touch input for the second device from the first device. In response to the orientation failing to satisfy the at least one criterion, the method also includes receiving touch input for the first device from the first device.

### BACKGROUND

An extended reality (XR) device incorporates a spectrum of technologies that blend physical and virtual worlds, including virtual reality (VR), augmented reality (AR), and mixed reality (MR). These devices immerse users in digital environments, either by blocking out the real world (VR), overlaying digital content onto the real world (AR), or blending digital and physical elements seamlessly (MR). XR devices that include headsets, glasses, or screens equipped with sensors, cameras, and displays that track movement of users and surroundings to deliver immersive experiences across various applications such as gaming, education, healthcare, and industrial training.

### SUMMARY

This disclosure relates to systems and methods for arbitrating touch input from a touch device to either the touch device or a second computing device. In some implementations, the touch device may represent a companion device, such as a smartphone, smartwatch, tablet, or some other touch device. In some implementations, the second device may represent an XR device or some other wearable device. In at least one implementation, the system will determine an orientation of the touch device in relation to a second device (i.e., XR device). From the orientation, touch input at the first device is assigned to either the touch device or the second device. As an example, if the orientation of a touch device and an XR device indicates the user of the XR device is viewing the touch device, then touch input at the touch device will be assigned to the touch device. In another example, if the orientation of the touch device and the XR device indicates the user is not viewing the touch device, then input at the touch device will be assigned to the XR device.

In some aspects, the techniques described herein relate to a method including: identifying an orientation of a first device relative to a second device; determining whether the orientation satisfies at least one criterion; in response to the orientation satisfying the at least one criterion, receiving touch input for the second device from the first device; and in response to the orientation not satisfying the at least one criterion, receiving touch input for the first device from the first device.

In some aspects, the techniques described herein relate to a computer-readable storage medium storing program instructions that when executed by at least one processor cause the at least one processor to execute operations, the operations including: identifying an orientation of a first device relative to a second device; determining whether the orientation satisfies at least one criterion; in response to the orientation satisfying the at least one criterion, receiving touch input for the second device from the first device; and in response to the orientation not satisfying the at least one criterion, receiving touch input for the first device from the first device.

In some aspects, the techniques described herein relate to an apparatus including: at least one processor; and a computer-readable storage medium storing program instructions that cause the at least one processor to: identify an orientation of a first device relative to a second device; determine whether the orientation satisfies at least one criterion; in response to the orientation satisfying the at least one criterion, receive touch input for the second device from the first device; and in response to the orientation not satisfying the at least one criterion, receive touch input for the first device from the first device.

The details of one or more implementations are set forth in the accompanying drawings and the description below. Other features will be apparent from the description and drawings, and from the claims.

### BRIEF DESCRIPTION OF THE DRAWINGS

FIG. 1 illustrates a system configured to arbitrate touch input based on orientation information according to an implementation.

FIG. 2 illustrates a method of assigning touch input from a touch device to the touch device or an XR device based on orientation information according to an implementation.

FIG. 3 illustrates an operational scenario of assigning touch input from a device according to an implementation.

FIG. 4 illustrates an operational scenario of assigning touch input from a device according to an implementation.

FIG. 5 illustrates an operational scenario of assigning touch input from a device according to an implementation.

FIG. 6 illustrates a method of assigning touch input from a touch device according to an implementation.

FIG. 7 illustrates an operational scenario of assigning touch input from a device according to an implementation.

FIG. 8 illustrates a method of assigning touch input from a touch device according to an implementation.

FIG. 9 illustrates a computing system to manage assignment of touch input from a touch device according to an implementation.

### DETAILED DESCRIPTION

Computing devices, such as wearable devices and extended reality (XR) devices, provide users with an effective tool for gaming, training, education, healthcare, and more. An XR device merges the physical and virtual worlds, encompassing virtual reality (VR), augmented reality (AR), and mixed reality (MR) experiences. These devices usually include headsets or glasses equipped with sensors, cameras, and displays that track users' movements and surroundings, allowing them to interact with digital content in real-time. XR devices offer immersive experiences by either completely replacing the real world with a virtual one (VR), overlaying digital information onto the real world (AR), or seamlessly integrating digital and physical elements (MR). Input to XR devices may be provided through a combination of physical gestures, voice commands, controllers, and eye movements. Users interact with the virtual environment by manipulating objects, navigating menus, and triggering actions using these input methods, which are translated by the device's sensors and algorithms into corresponding digital interactions within the XR space. However, a technical problem exists in providing precise and efficient inputs to the XR device using current input methodologies.

In addition to XR devices, many users possess and use a variety of companion devices (referred to herein as touch devices), such as smartphones, smartwatches, and tablets, which are handheld electronic devices equipped with a touchscreen interface that allows users to interact with the device by directly touching the screen with their fingers or a stylus. Through intuitive gestures (i.e., touch input, tapping, swiping, and pinching), users can navigate through menus, launch applications, input text, and/or manipulate on-screen elements.

As at least one technical solution, an application can be configured to assign touch inputs from a touch device to the XR device when criteria are met. In at least one implementation, the application executes on the touch device and/or the XR device. The application may include a function or a set of functions that run in the background to support the touch input arbitration to multiple devices. The application may not have a user interface in some examples. The application can be configured to determine whether the user is viewing the touch device and assigns touch input based on the determination. For example, the application may identify orientation information for both a smartphone and an XR device and determine whether the user is viewing the smartphone based on the orientation information. If the user is actively viewing the touch device, then the application will direct touch inputs at the touch device to the touch device. However, if the user is not actively viewing the touch device, then the application will direct touch inputs at the touch device to the XR device. The technical effect permits a touch device to provide touch input for the XR device (or other computing device), adding an efficient input device for an end user via existing hardware.

As described herein, the orientation of a first device (e.g., touch device) relative to a second device (e.g., XR device) describes the angular relationship and direction the first device is facing or positioned in comparison to the second device. For the angular component from a touch device, an orientation vector may be identified for the touch device. An orientation vector for a touch device describes the three-dimensional direction in which the device is oriented in space. In some examples, the orientation vector represents the direction that the screen of the device is facing. The orientation vector can be measured using the sensors of the device such as accelerometers and/or gyroscopes. The orientation vector may also be measured using cameras on the touch device or another device in some examples. This vector helps in determining how the device is tilted or rotated from a reference position.

In addition to the orientation vector for the touch device, an orientation vector may also be determined for the XR device as a second angular component to the angular relationship. The orientation vector for the XR device may indicate the three-dimensional direction and orientation of the device in space, usually measured in terms of roll, pitch, and yaw. In some examples, the orientation vector indicates the direction and orientation of the gaze associated with the device and/or the user of the device. Gaze in the context of XR or wearable devices refers to the direction in which a user is looking, as detected by tracking the orientation and position of their eyes or head. The orientation may be determined via sensors, such as gyroscopes, accelerometers, eye tracking hardware (IR sensors), cameras, or some other system.

In at least one technical solution, an application identifies an orientation of a first device (e.g., touch device) relative to a second device (e.g., XR device). In at least one implementation, the application identifies the orientation using accelerometers, gyroscopes, or some other sensor on the first device and the second device. As an example, for an XR device, the device uses a combination of sensors, such as accelerometers, gyroscopes, and magnetometers. The sensors track the device's movement and orientation in a three-dimensional space that can be used by applications to update displays or provide some other application. Here, the sensor information from the first and second devices is used to generate orientation vectors. An orientation vector is a mathematical vector that indicates the direction in which an object is pointed. For example, the orientation vector for an XR device may indicate the direction of the user's head, while the orientation vector for a touch device may indicate the direction of the screen. Once the orientation vectors are determined for both the first and the second device, the application may identify or calculate an angle between the orientation vector for the first device and the orientation vector for the second device. The angle may then be compared to a threshold to determine whether the user is viewing the touch device or is looking away from the touch device. If the angle is within the threshold, the application determines that the user is actively viewing the touch device (first device) and directs touch inputs from the touch device to the touch device. If the angle is not within the threshold, the application directs touch inputs from the touch device to the XR device (second device).

In another technical solution, an application identifies orientation information for the first device (touch device) and the second device (XR device) based on the gaze of the user and image data from the XR device. For example, the second device may comprise an XR device. Sensors on the XR device may track the gaze of the user. Gaze tracking refers to the technology that detects and follows the direction and focus of a user's eyes within a virtual or augmented environment. Gaze tracking is accomplished using a combination of hardware and software components. The hardware often includes infrared (IR) emitters and cameras integrated into the headset, which emit IR light detected by the cameras after reflecting off the user's eyes. This setup allows the system to determine the position and movement of the eyes. Software algorithms then analyze this data to calculate the direction of the gaze and the point of focus within the environment. In addition to the gaze information, cameras or image sensors may capture images of the field of view associated with the user. The cameras on the XR device may be used for various purposes, such as tracking the user's movements, detecting hand gestures, enabling augmented reality experiences by understanding the real-world environment, implementing facial recognition for authentication or personalized experiences, and supporting features like gaze tracking or object recognition. Here, the image data from the cameras may be processed to determine the location and orientation of the touch device relative to the user's gaze. In at least one implementation, the XR device can identify a gaze vector from the user and determine whether the orientation vector of the touch device derived from an outward captured image intersects the user's gaze (i.e., the angle of the gaze vector and the orientation vector are less than the threshold value). If the application determines that the touch device is in the gaze of the user, the application may direct touch input on the touch device to the touch device. However, if the application determines that the touch device outside the gaze of the user or the orientation of the touch device does not indicate that the user is actively interacting with the touch device, then the application may direct touch input on the touch device to the XR device. The input may be used to interact with menus, select objects, or perform some other action in association with the user interface of the XR device.

In at least one technical solution, a camera on the touch device can capture image data and an application can determine whether the user is actively viewing the touch device from the image data. For example, an application executing on the touch device may determine whether the gaze of the user is actively viewing the screen of the touch device via a front facing camera on the touch device. The application may consider factors, such as the angle of the user's head, eye tracking information, or some other information associated with the view and gaze of the user. If the user is actively viewing the touch device, then touch input on the touch device may be directed to the touch device by the application. However, if the gaze of the user is not actively viewing the touch device, then touch input on the touch device may be directed to the XR device. The technical effect allows the user to use a single touch device to provide input to both the touch device and the XR device.

Although demonstrated in the previous examples as arbitrating or assigning touch input based on the orientation of the devices, similar operations can be performed to assign other input or output operations based on the orientation. In at least one implementation, notifications can be assigned for display at either the touch device or the XR device based on the orientation of the touch device relative to the XR device. A notification is a message or alert that is displayed on the screen to inform the user about an event, update, or action needed from an application or one of the devices. Examples of notifications may include text messages, emails, application updates, or some other notification. In at least one example, when the orientation satisfies at least one criterion, notifications may be presented or displayed on the XR device. Alternatively, when the orientation fails to satisfy the at least one criterion, notifications may be presented or displayed on the touch device. In another implementation, natural language commands may be processed by either the XR device or the touch device based on the orientation of the touch device relative to the XR device. For example, when the orientation satisfies criteria, the natural language command is processed via the XR device. Alternatively, when the orientation fails to satisfy the criteria, the natural language command is processed via the touch device. The technical effect permits an application to arbitrate and manage inputs and outputs for different devices based on the relative orientations of the devices. Although these are example input/output arbitrations, other input/output operations may be directed to either the XR device or the touch device based on the relative orientation between the devices.

Various embodiments of the present technology provide for a wide range of technical effects, advantages, and/or technical solutions for computing systems and components. For example, various implementations may include one or more of the following technical effects, advantages, and/or improvements: 1) non-routine and unconventional use of a touch device to provide input for a secondary wearable or XR device; and 2) non-routine and unconventional operations to switch from providing touch input to the touch device to providing input to the wearable or XR device.

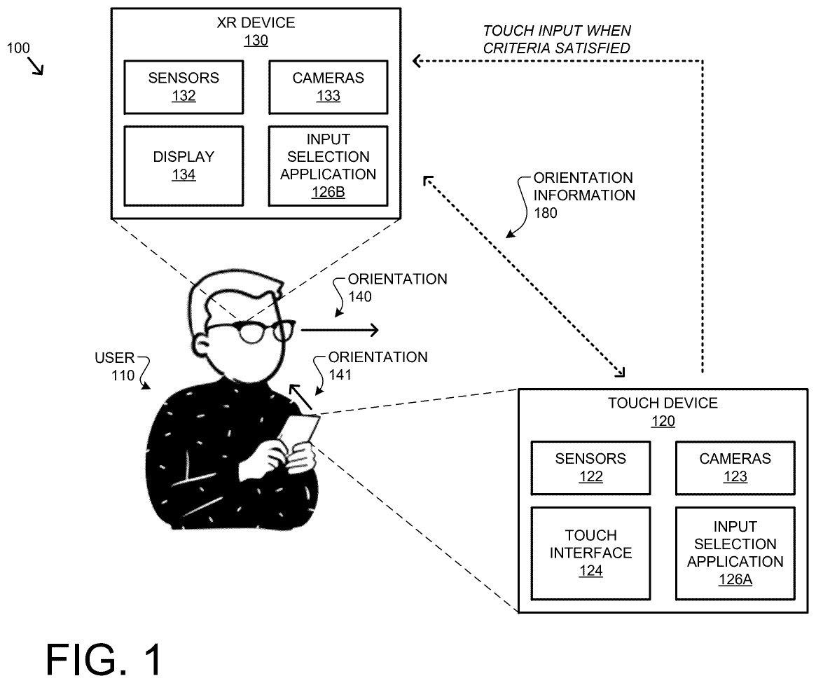

FIG. 1 illustrates a system 100 configured to arbitrate touch input based on orientation information according to an implementation. System 100 includes user 110, touch device 120, XR device 130, orientations 140-141, and orientation information 180, which may be exchanged between the devices. Touch device 120 further includes sensors 122, cameras 123, and touch interface 124. XR device 130 further includes sensors 132, cameras 133, and display 134. Touch device 120 and XR device 130 provide input selection applications 126A-126B. Although demonstrated as being distributed in the example of system 100 as input selection applications 126A-126B, similar operations may be performed locally at each of the devices. Input selection applications 126A-126B may comprise a function or a set of functions that run in the background to support the touch input arbitration to different. The application may not have a user interface in some examples.

Input selection applications 126A-126B identify the orientation of touch device 120 relative to XR device 130 and assign touch input to touch device 120 or XR device 130 based on the identified orientation. In at least one implementation, input selection applications 126A-126B may determine whether user 110 is viewing touch device 120 based on the identified orientation of touch device 120 relative to XR device 130. If user 110 is viewing touch device 120, then touch input from touch device 120 is directed to touch device 120 and the corresponding applications or applications on the touch device 120. If user 110 is not viewing touch device 120, then touch input from touch device 120 is directed to XR device 130 and a cursor or other interface element available on XR device 130.

In system 100, user 110 wears XR device 130. XR device 130 is an example of a device designed to blend digital content with the physical world, encompassing virtual reality (VR), augmented reality (AR), and mixed reality (MR) experiences. XR device 130 may include a headset equipped with a display 134, cameras 133 for environmental scanning and motion tracking, sensors 132 such as accelerometers, gyroscopes, and/or magnetometers for orientation and/or movement detection, and sometimes additional hardware for eye and hand gesture tracking. In some implementations, XR device 130 may further include speakers or headphones for audio and microphones for voice commands and communication.

In addition to XR device 130, system 100 further includes touch device 120 associated with user 110 (touch device 120 may be referred to as a companion device in some examples). Touch device 120 may include a smartphone, tablet, smartwatch, or some other type of touch device. Touch device 120 may include a capacitive or resistive touchscreen or touch interface 124, a processor, memory, storage, an operating system, sensors 122 like accelerometers and gyroscopes, cameras 123, and various connectivity options such as Bluetooth, Wi-Fi, and cellular networks. These components enable users to interact with the device through touch input gestures like tapping, swiping, scrolling, and pinching.

In an example operation of system 100, touch device 120 and XR device 130 may identify orientations 140-141 for their corresponding device. The orientations may be derived using accelerometers, gyroscopes, or some other sensor of sensors 122 and sensors 132. In some implementations, orientations 140-141 may each represent a vector that indicates the direction in which the device is pointed. From the orientations, input selection applications 126A-126B may identify the orientation of touch device 120 relative to XR device 130. In some examples, the relative orientation of touch device 120 to XR device 130 may be represented as an angle between the vectors for orientations 140-141. If the angle exceeds a threshold value, input selection applications 126A-126B may direct input from touch device 120 to XR device 130. However, if the angle does not exceed the threshold, then touch input from touch device 120 may be directed to touch device 120.

In some examples, an orientation vector for a touch device may be determined using onboard sensors such as accelerometers, gyroscopes, and/or magnetometers. These sensors measure linear acceleration, angular velocity, and/or magnetic fields, respectively, to calculate the device's orientation in space by tracking its roll (rotation around the x-axis), pitch (rotation around the y-axis), and yaw (rotation around the z-axis) relative to a fixed reference, usually the Earth's surface. The measurements are then combined with a known location of the outward facing screen on the device to determine an orientation vector for the screen (e.g., a direction orthogonal to a plane aligned along a display of the device). Similar sensors on an XR device may provide additional measurements that are used to define a second orientation vector corresponding to the gaze direction for the device on the user.

In some implementations, the orientation may be determined exclusively from data from touch device 120 or XR device 130. In the example of touch device 120, touch device 120 may capture image data using a camera of cameras 123. From the captured images, the input selection application 126 identifies the gaze of user 110 and determines an orientation (i.e., angle) from the orientation vector of touch device 120 relative to the gaze of user 110. When the orientation indicates user 110 is viewing touch device 120 (i.e., the angle is below a threshold), touch input from touch device 120 is directed to touch device 120. However, when the orientation indicates user 110 is not viewing touch device 120 (i.e., the angle satisfies a threshold), touch input from touch device 120 is directed to XR device 130.

In the example of using XR device 130, sensors 132 may capture orientation data associated with the gaze of user 110 while cameras 133 may capture an image of touch device 120. From the gaze and the image data, the input selection application may determine an orientation (e.g., angle) of touch device 120 relative to the gaze associated with XR device 130. When the orientation indicates user 110 is viewing touch device 120, touch input from touch device 120 is directed to touch device 120. However, when the orientation indicates user 110 is not viewing touch device 120, touch input from touch device 120 is directed to XR device 130. In some implementations, the gaze may be determined using IR sensors, gyroscopes, accelerometers, or some other sensor of sensors 132.

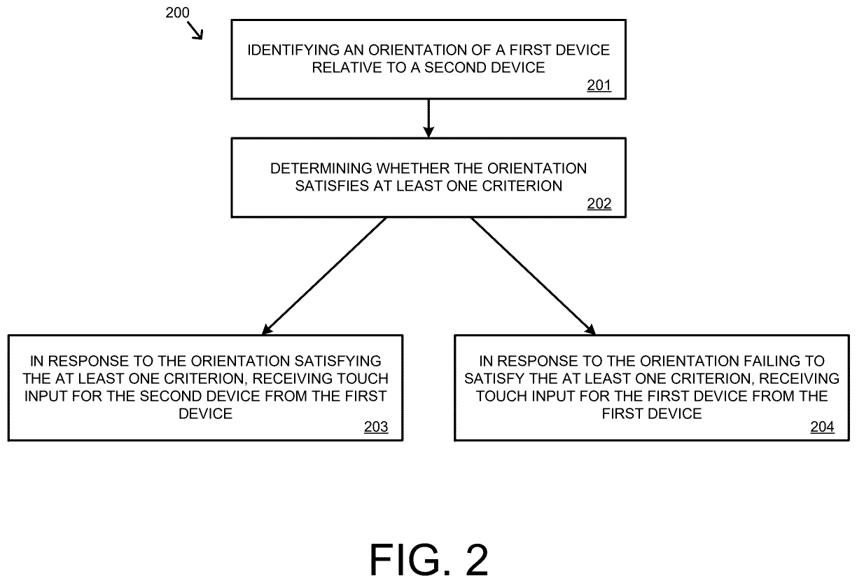

FIG. 2 illustrates a method 200 of assigning touch input from a touch device to the touch device or an XR device based on orientation information according to an implementation. The steps of method 200 are referenced in the paragraphs that follow with reference to elements of system 100 of FIG. 1. Method 200 may be implemented using touch device 120 and/or XR device 130.

Method 200 includes identifying an orientation of a first device relative to a second device at step 201. In some examples, the first device represents a touch device, such as touch device 120, while the second device represents an XR device, such as XR device 130. In at least one implementation, the orientation is determined based on orientation vectors calculated from sensor data on each of the first device and the second device. Once the orientation vectors are calculated, an angle is identified between the vectors and used as the orientation of the first device relative to the second device. For example, the vector for orientation 140 may be combined with the vector orientation 141 to identify the angle.

In another implementation, the orientation of the first device relative to the second device may be determined based on gaze and image data from the second device. In at least one example, gaze tracking information from XR device 130 and image data from XR device 130 may be combined to define an orientation of the touch device relative to the XR device. In at least one example, the orientation may define the location and orientation of the touch device in the user's gaze or view. In some implementations, gaze is identified using eye-tracking technology, which involves infrared cameras and sensors that monitor the position and movement of the user's eyes. This data is analyzed to determine the point in the environment where the user is looking. The gaze is then correlated to image data derived from outward facing cameras on the device to determine the location and orientation of the touch device in the view of the user. In at least one example, the orientation may be represented as an angle. The angle is determined based on the orientation vector associated with the gaze of user 110 and the orientation vector for touch device 120 relative to the gaze of user 110.

In at least one implementation, the orientation of the first device relative to the second device may be determined based on image data captured by a front facing camera on the first device (i.e., touch device 120). To determine the orientation, the front facing camera captures one or more images and the gaze of user 110 is determined from the one or more images. The gaze may then be used to define the orientation of the first device (touch device) relative to the second device (i.e., the user's view in relation to the orientation of the touch device). In at least one example, the orientation may represent an angle based on an orientation vector of touch device 120 and the orientation vector for XR device 130 (or the user gaze) determined from the image data.

Once the orientation is identified, method 200 further includes determining whether the orientation satisfies at least one criterion at step 202. In response to the orientation satisfying the at least one criterion, method 200 provides for receiving touch input for the second device from the first device at step 203. Alternatively, in response to the orientation not satisfying the at least one criterion, method 200 provides for receiving touch input for the first device from the first device at step 204.

In some implementations, when the orientation represents an angle from the combined orientation vectors of the first device and the second device, the at least one criterion comprises a threshold angle. For example, the orientation vectors for orientations 140-141 can be combined into an angle that represents the orientation of touch device 120 relative to XR device 130. The angle is then compared to a threshold to determine whether the angle exceeds the threshold. If exceeded, indicating that user 110 is not actively viewing touch device 120, touch input at touch device 120 is direct to XR device 130. The touch input may be used to manipulate menus, select objects, move a cursor, or provide some other interaction in association with the interface of XR device 130. If the threshold is not exceeded, then touch input from touch device 120 is assigned to touch device 120 and the corresponding applications thereon. The touch input may be communicated to XR device 130 using Bluetooth, Wi-Fi, or some other communication protocol.

In some implementations, when the orientation of the touch device 120 in relation to XR device 130 is derived from the gaze data and image data from XR device 130, the at least one criterion may comprise a threshold angle. For example, a vector for orientation 141 of touch device 120 may be determined from the image data and gaze data, while a vector for orientation 140 of XR device 130 is derived at least partially from the gaze data (and may be supplemented with other sensor data, such as gyroscopes and accelerometers). The vectors may be combined as an angle that is compared to thresholds. When the angle is less than a threshold (i.e., user 110 is actively looking at or interfacing with touch device 120), touch input from touch device 120 will be directed to touch device 120. When the angle is greater than a threshold (i.e., user 110 is looking away from or not interacting with an application on touch device 120), touch input from touch device 120 will be provided to XR device 130.

In some implementations, when the orientation of touch device 120 in relation to XR device 130 is derived from the image data on touch device 120, the orientation may comprise an angle defined from a vector of the user's gaze to an orientation vector of touch device 120. When the angle satisfies a threshold, indicating that the user is looking away from touch device 120, then touch input at touch device 120 will be directed to XR device 130. When the angle fails to satisfy the threshold, indicating that the user is looking near or at touch device 120, then touch input at touch device 120 will be directed to touch device 120.

In some examples, the threshold angle value (i.e., criterion) is manually configured for the first device and the second device. In some examples, the threshold angle value is based on a model trained using examples of user's looking at the touch device to interact with the touch device and looking away from the touch device while providing input to the XR device. In some implementations, the model includes a machine learning model. A machine learning model is a mathematical model that learns patterns from data. It adjusts its parameters through a training process to make predictions or decisions without being explicitly programmed to perform the task. Here, the model is trained from a knowledge base of user's interacting with the touch device to provide input to either the touch device or the XR device. The model determines angles or orientation measurements that are indicative of the user attempting to interact with applications on the touch device or applications on the XR device.

In some implementations, in determining the orientation of the touch device relative to the XR device, other sensors and/or communication technologies may be used to identify the relative orientations. In some examples, ultra-wideband (UWB) orientation may be used by at least one of the devices to determine the relative orientation. UWB orientation refers to the use of ultra-wideband technology to determine the orientation or directionality of an object or device relative to others. This capability stems from UWB's highly accurate distance and location measurement features, which can track the angle or alignment of devices with precision. UWB orientation works by emitting short, low-energy pulses across a broad range of frequencies, which allows for the precise measurement of the time it takes for these signals to travel between UWB-enabled devices (e.g., the XR and touch device). Here, UWB may be used to determine the orientation of the touch device relative to the XR device and determine where to direct touch input on the touch device based on the orientation. The touch input may be directed to the XR device when the orientation (e.g., orientation angle derived from UWB) satisfies criteria indicative of the user looking away from the touch device. Alternatively, the touch input may be directed to the touch device when the orientation fails to satisfy the criteria. Failing to satisfy the criteria is indicative of the user actively viewing or interacting with the touch device.

In some examples, the devices may use direction finding using Bluetooth to determine the relative orientation. Direction finding using Bluetooth enables devices to determine the direction of a Bluetooth signal. This may be achieved using either Angle of Arrival (AoA) or Angle of Departure (AoD) methodologies, which involve measuring the direction from which a Bluetooth signal is being received or the direction in which it is being transmitted. This technology enables accurate location services and tracking applications. Here, the touch device and/or the XR device may employ direction finding using Bluetooth to determine the relative orientation between the devices (i.e., touch and XR device) and assign touch input received at the touch device to one of the devices based on the orientation. While UWB and Bluetooth Direction Finding are some example technologies for determining the orientation between devices, other orientation calculating techniques may be used to arbitrate touch input.

In some implementations, in addition to the orientation of the first device relative to the second device, a system may further arbitrate touch input based on other criteria. For example, the system may consider the state of the touch device or the screen of the touch device. In at least one example, the system may determine whether the screen is active on the touch device providing a greater likelihood of the user viewing the touch device. In contrast, if the screen is inactive, then the system may determine that the user is less likely to be viewing the touch device. The screen activity may be used to supplement the orientation of the first device to the second device and provide context in fringe examples for determining whether the user is viewing or not viewing the touch device. Other criteria may also include the rotation of the devices relative to one another. For example, if touch device 120 is upside down relative to XR device 130, then the system may determine that the user is not viewing touch device 120.

Although demonstrated in the example of method 200 as directing touch input to either the touch device or the XR device, similar operations can be performed to distribute other tasks or notifications between the touch device and the XR device. In at least one implementation, when a notification is received (e.g., a text notification, email notification, or some other push notification), an application executing on the XR device and/or touch device may determine whether the user is actively viewing the touch device. For example, the application may identify an orientation of the touch device relative to the XR device and determine whether the orientation satisfies criteria to indicate that the user is looking away from the touch device. If the user is looking away from the touch device, then the application causes the notification to be displayed on the XR device. However, if the user is looking at the touch device, then the application causes the notification to be displayed on the touch device. Although this is one example of arbitrating input/output between devices, other examples may include directing voice input to the touch device or the XR device, directing sound to the touch device or the XR device, or some other arbitration of input or output. As one example, the device may identify the orientation of the touch device relative to the XR device and determine whether to play the audio from the touch device or audio on the XR device based on the orientation. Thus, when the user is viewing the touch device, audio may be played from the touch device, whereas when the user is not viewing the touch device, audio may be played from the XR device and not the touch device.

As another example, voice input may be directed to either the touch device or the XR device based on the orientation of the touch device relative to the XR device. For example, when a user provides a natural language command, such as a request to play an audio recording, a device is selected to process the request based on the orientation of the touch device relative to the XR device. When the orientation corresponds to the user looking away from the touch device (i.e., the orientation satisfies the at least one criterion), then the voice command may be processed by the XR device. When the orientation corresponds to the user looking at the touch device (i.e., the orientation fails to satisfy the at least one criterion), then the voice command may be processed by the touch device.

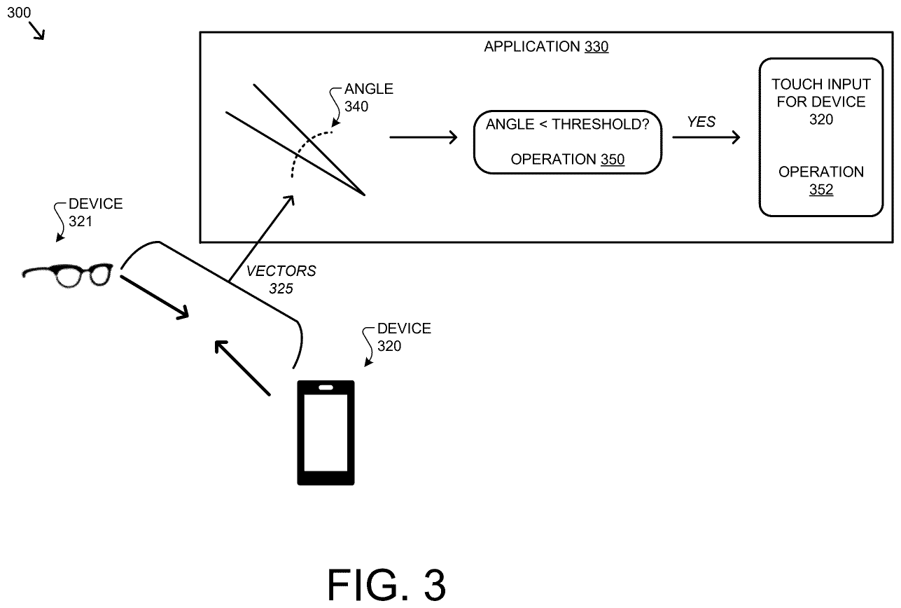

FIG. 3 illustrates an operational scenario 300 of assigning touch input from a device according to an implementation. Operational scenario 300 includes devices 320-321, vectors 325 and application 330 that identifies angle 340 and applies operations 350-351. Application 330 may be employed by an XR device, a touch device, or some combination thereof.

In operational scenario 300, application 330 identifies vectors 325 that correspond to the orientations of devices 320-321. The orientation vector for device 320, which is representative of a touch device, indicates the direction and angle at which the device is held or positioned relative to a standard reference frame, such as when the device is tilted or rotated. For example, the vector for device 320 may indicate the direction at which the screen is pointed (e.g., a direction orthogonal to a plane aligned along a display of the device). Additionally, the vector for device 321 may indicate the direction of the gaze associated with the user (e.g., the direction that the glasses, goggles, or other XR device is outwardly facing), wherein the vector may be determined from a gyroscope, accelerometer, or some other sensor. Once vectors 325 are identified, application 330 determines angle 340 indicative of the orientation of device 320 relative to device 321.

After determining angle 340, application 330 determines whether angle 340 is less than a threshold value at operation 350. When application 330 determines that angle 340 is less than the threshold value, application 330 directs touch input at device 320 to be used in association with device 320. The touch input may include gestures such as tapping, swiping, and pinching, to navigate through menus, launch applications, input text, and manipulate on-screen elements for device 320.

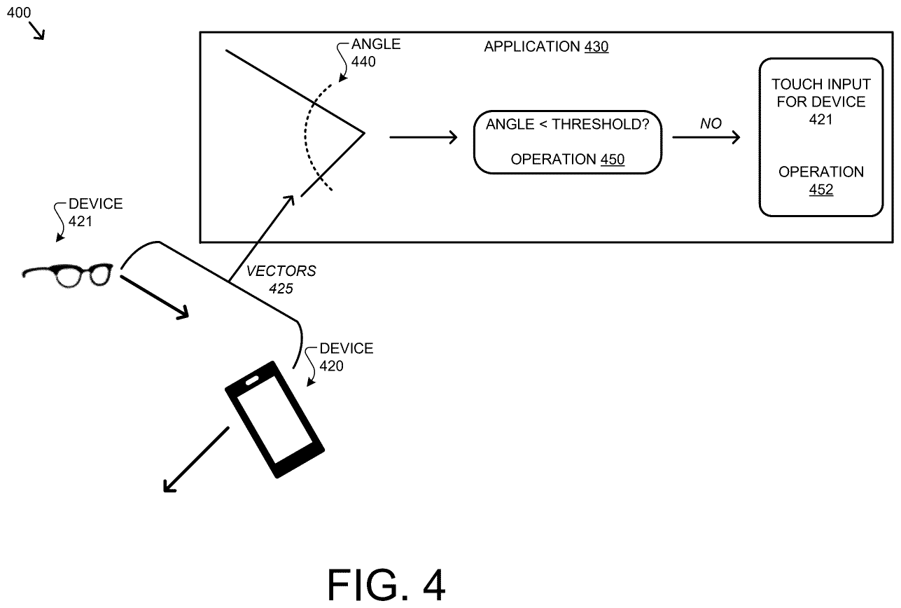

FIG. 4 illustrates an operational scenario of assigning touch input from a device according to an implementation. Operational scenario 400 includes devices 420-421, vectors 425 and application 430 that identifies angle 440 and applies operations 450-451. Application 430 may be employed by an XR device, a touch device, or some combination thereof.

In operational scenario 400, application 430 identifies vectors 425 that correspond to the orientations of devices 420-421. The orientation vector for device 420, which is representative of a touch device, indicates the direction and angle at which the device is held or positioned relative to a standard reference frame, such as when the device is tilted or rotated. For example, the vector for device 420 may indicate the direction at which the screen is pointed (e.g., the direction that the glasses, goggles, or other XR device is outwardly facing). Additionally, the vector for device 421 may indicate the outward direction of the screen associated with the user, wherein the vector may be determined from a gyroscope, accelerometer, or some other sensor. Once vectors 425 are identified, application 430 determines angle 440 indicative of the orientation of device 420 relative to device 421.

Operational scenario 400 further determines whether angle 440 is less than a threshold value at operation 450. When it is determined that the angle is not less than the threshold, application 430 directs touch input received at device 420 to device 421 at operation 450. As a technical effect, the touch device may be used to interface as a smartphone, tablet, or other similar touch device for the user and support touch input for an XR device when the user is not actively interfacing or viewing the touch device.

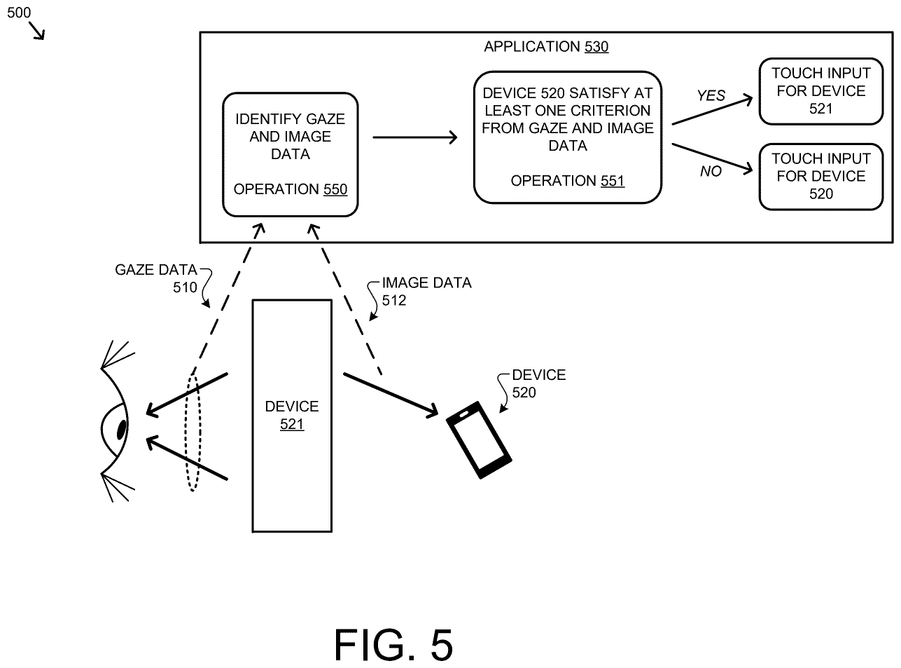

FIG. 5 illustrates an operational scenario 500 of assigning touch input from a device according to an implementation. Operational scenario 500 includes devices 520-521 and application 530. Application 530 may execute on device 520 and/or device 521. Device 521 is representative of an XR device in some examples. Device 520 is representative of a touch device, such as a smartphone, smartwatch, tablet, or some other touch device in some examples. Application 530 provides operations 550-551.

In operational scenario 500, application 530 identifies gaze data 510 and image data 512 from device 521 as part of operation 550. Device 521 tracks gaze data 510 using sensors and/or cameras to detect the position and movement of a user's eyes. The sensors may comprise IR sensors, gyroscopes, or some other sensor to track the gaze of the user. Device 521 further captures image data 512 using one or more outward positioned cameras to identify objects in the field of view for the user. Once gaze data 510 and image data 512 are identified, application 530 performs operation 551 to determine whether device 520 satisfies at least one criterion from gaze data 510 and image data 512. When the at least one criterion is satisfied, the touch input from device 520 is directed to device 521. The touch inputs may be communicated to device 521 using Bluetooth, Wi-Fi, or some other communication standard. However, when the at least one criterion is not satisfied, touch input at device 520 may be directed to device 520 and any corresponding application or application thereon.

In at least one implementation, application 530 may determine an orientation angle of device 520 relative to device 521. The orientation angle may be calculated from the gaze orientation of the user associated with device 521 relative to the position of device 520 in image data 512. For example, when device 520 is pointed away from device 521, the orientation angle may be large, while when device 520 is pointed at device 521 and the user's gaze, the orientation angle may be small. In some implementations, the orientation angle is compared to a threshold value that is used as the at least one criterion. When the orientation angle does not exceed the threshold value, then touch input from device 520 is provided to device 521. When the orientation angle exceeds the threshold value, then touch input from device 520 will be provided to device 521. As a technical effect, when the user is determined to be actively viewing device 520, touch input will be directed to device 520. However, when the user is not actively viewing device 520, device 520 may function as a supplemental input device for device 521.

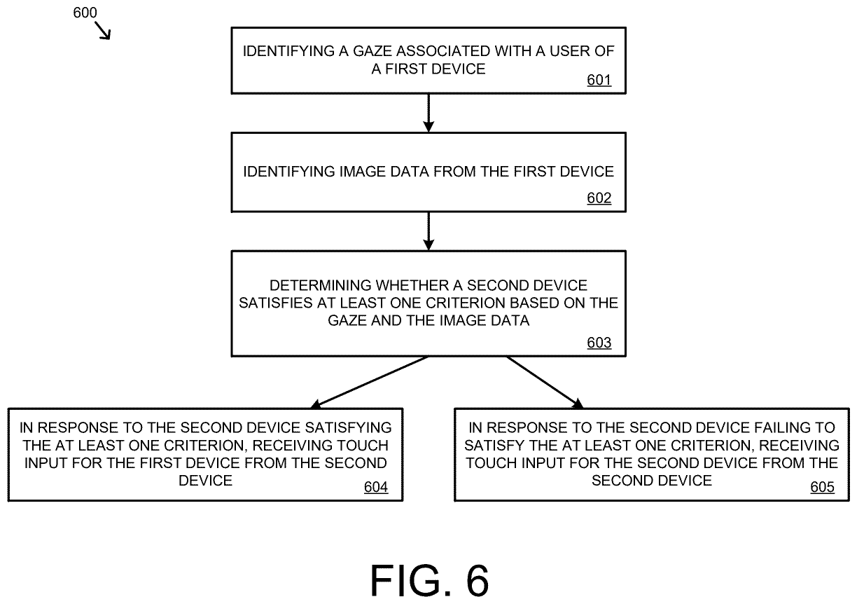

FIG. 6 illustrates a method 600 of assigning touch input from a touch device according to an implementation. The steps of method 600 are referenced in the paragraphs that follow with reference to elements of operational scenario 500 of FIG. 5. Method 600 may be performed on an XR device (or other type of wearable device) and/or may be performed on a touch device, such as a smartphone or watch.

Method 600 includes identifying a gaze associated with a user of a first device at step 601 and identifying image data from the first device at step 602. In some implementations, the first device is representative of an XR device or other wearable device by a user. The gaze data may represent a vector determined from various sensors and/or cameras associated with tracking the movement of eyes and the head of the user. The image data may comprise one or more images from outward facing cameras of the first device to capture orientation information associated with a second device. In the example of operational scenario 500 device 521 captures gaze data associated with the user and image data 512 from outward facing cameras capable of capturing an image of device 520.

Method 600 further includes determining whether a second device satisfies at least one criterion based on the gaze and the image data at step 603. In some implementations, the method may determine an orientation angle of the second device relative to the gaze (i.e., orientation) of the user. In at least one example, the method may combine the gaze data as a first vector (direction of the user's gaze associated with the first device) and the orientation vector of the second device (direction of the second device's screen) derived from the image data as an angle. The method will then determine whether the angle satisfies a threshold value (i.e., satisfies a criterion) to determine where to direct touch input from the second device.

In response to the second device satisfying the at least one criterion, method 600 further includes receiving touch input for the first device from the second device at step 604. Returning to the example of an orientation angle of the second device relative to the gaze of the user, when the orientation angle indicates that the user is looking away from the second device (i.e., the orientation angle satisfies a threshold), then touch input is provided from the second device to the first device. For example, a smartphone may have touch input provided to an XR device to provide various cursor and selection operations on the XR device.

In response to the second device failing to satisfy the at least one criterion, method 600 further provides for receiving touch input for the second device from the second device at step 605. Using the example of an orientation angle of the second device relative to the gaze of the user at the first device, when the orientation angle indicates that the user is looking at or interacting with the second device (i.e., the orientation angle fails to satisfy the threshold), then touch input is provided from the second device to the second device. For example, when the user of an XR device is actively viewing a smartphone. The touch input at the smartphone will be directed to operations and applications on the smartphone.

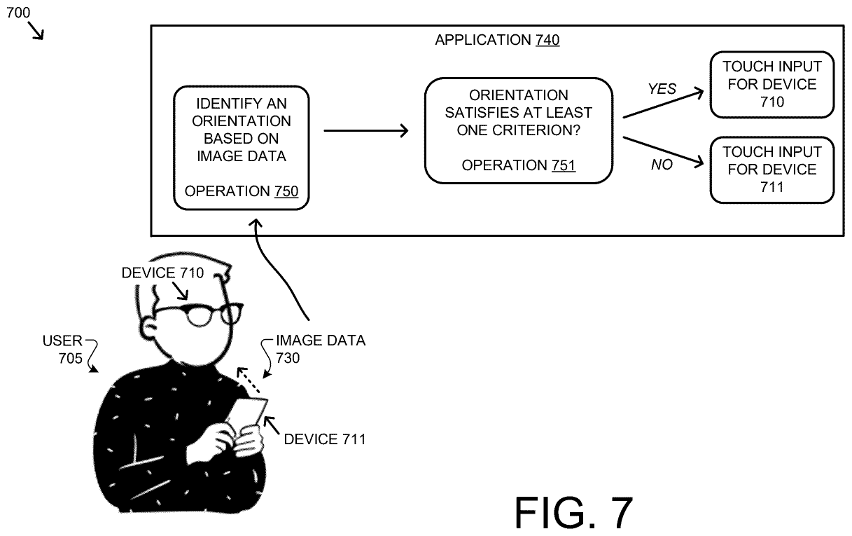

FIG. 7 illustrates an operational scenario 700 of assigning touch input from a device according to an implementation. Operational scenario 700 includes user 705, devices 710-711, image data 730, and application 740. Application 740 may be executed on device 710 and/or device 711 in some examples. Application 740 includes operation 750 and operation 751. Device 710 may be representative of an XR device. Device 711 may be representative of a smartphone, smartwatch, tablet, or some other touch device.

In operational scenario 700, application 740 receives image data 730 from device 711. In response to receiving image data 730, application 740 performs operation 750 that identifies an orientation of device 711 relative to the gaze of user 705 of device 710. In some implementations, operation 750 may determine an angle associated with the gaze vector in relation to the orientation of device 711 derived from image data 730. Once the orientation is identified, application 740 performs operation 751 that determines whether the orientation of device 711 in relation to the orientation of the gaze satisfies at least one criterion. If the orientation does satisfy the at least one criterion, application 740 directs touch input from device 711 to device 710. If the orientation does not satisfy the at least one criterion, application 740 directs touch input from device 711 to device 711 to interact with local applications and/or applications.

In at least one implementation, when the orientation represents an angle of the user gaze in relation to the orientation of device 711, the at least one criterion may comprise a threshold value. When the value is satisfied, indicating that user 705 is not actively viewing device 710, application 740 directs touch input from device 711 to device 710 to provide an additional user input mechanism for device 710. When the value is not satisfied, indicating that user 705 is actively viewing elements in association with device 711, application 740 directs touch input from device 711 to device 711 to provide local input for the device.

In some implementations, in addition to arbitrating the touch input based on the orientation of the devices, application 740 may further consider whether the screen is active in association with device 711. For example, in addition to determining whether the orientation indicates that the user is actively viewing device 711, application 740 may identify a screen state of device 711. If the screen of device 711 is not actively displaying information or is in a standby mode, application 740 may determine that the user is not actively using device 711 and may direct input to the device 710. As a technical effect, an application can consider both the orientation of the devices and the screen state of the touch device to determine an assignment of touch input from the touch device.

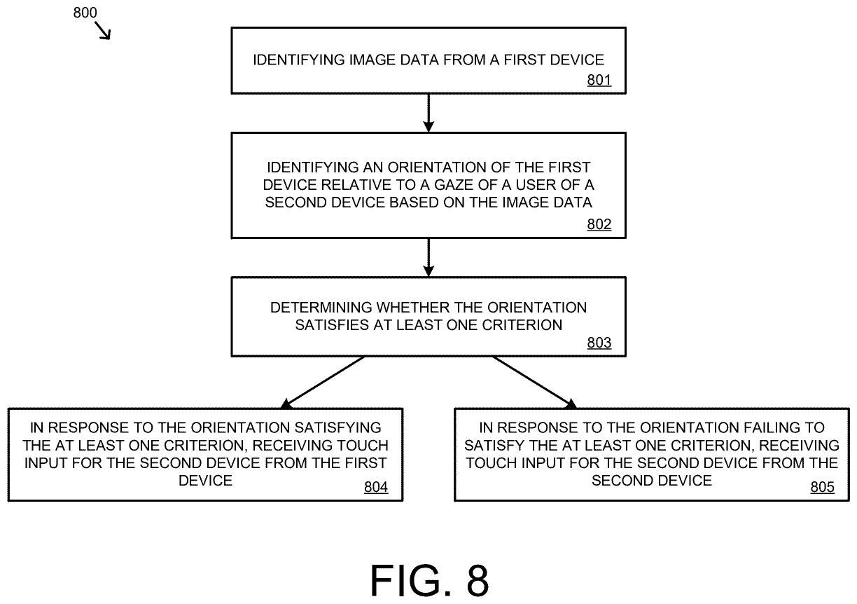

FIG. 8 illustrates a method 800 of assigning touch input from a touch device according to an implementation. Method 800 is described in the paragraphs that follow with reference to elements of operational scenario 700 of FIG. 7. Method 800 may be implemented by an XR device, a touch device, or some combination thereof.

Method 800 includes identifying image data from a first device at step 801. In some implementations, the image data may comprise one or more images from a front facing camera on the first device, the first device representing a smartphone, smartwatch, tablet, or some other touch device. Method 800 further includes identifying an orientation of the first device relative to the gaze of a user of a second device (e.g., XR device) based on the image data at step 802. In at least one implementation, the method determines a gaze vector of the user relative to the orientation vector of the first device derived from the image data.

Method 800 further provides for determining whether the orientation satisfies at least one criterion at step 803. In at least one implementation, the method identifies an angle of the first device relative to the gaze of the user at the second device from the image data. Once the angle is determined, the method then determines whether the angle exceeds a threshold value (e.g., indicates that the user is not looking at the first device). In response to the orientation satisfying the at least one criterion, indicating that the user is not looking at the touch device, method 800 includes receiving touch input for the second device from the first device at step 804. For example, when user 705 is determined not to be viewing device 711 from the orientation derived from image data 730, device 711 may accept touch input and communicate the touch input to device 710. The touch input may be communicated using Bluetooth, Wi-Fi, or some other communication protocol from device 711 to device 710.

In response to the orientation failing to satisfy the at least one criterion, method 800 includes receiving touch input for the first device from the first device at step 805. In at least one example, when user 705 is determined to be viewing device 711 from the orientation derived from image data 730, device 711 may accept touch input and apply the touch input to local applications and applications of device 711.

In some implementations, a system may use other hardware and software to determine the relative orientation of two devices. In at least one example, the system may use UWB. UWB orientation refers to the use of ultra-wideband technology to determine the precise orientation or directionality of an object or device relative to others. UWB orientation works by emitting short, low-energy pulses across a broad range of frequencies, which allows for the precise measurement of the time it takes for these signals to travel between UWB-enabled devices (e.g., the XR and touch device). In other implementations, the system may employ direction finding using Bluetooth to determine the relative orientation. Direction Finding using Bluetooth determines the orientation between two devices by using Angle of Arrival (AoA) or Angle of Departure (AoD) methods to accurately measure the directionality of Bluetooth signals received or sent by an antenna array. Accordingly, based on Bluetooth signals between the XR and the touch device, the devices may determine the orientation of the touch device relative to the XR device. The orientation, which may be defined by an angle in some examples, may then be compared to at least one criterion to determine the arbitration of touch input.

Although demonstrated in the examples of FIGS. 1-8 as assigning touch input to two different devices based on the orientation of the two devices, a system may arbitrate or assign other input or output based on the orientation. Examples of input or output may include notifications being displayed at one device over the other, receiving voice commands at one device over the other, or some other input or output. In at least one implementation, when the orientation of the first device (e.g., touch device) relative to the second device (e.g., XR device) satisfies criteria indicative of the user looking away from the second device, voice input or voice commands may be selectively received and processed via the XR device. However, when the orientation of the first device relative to the second device does not satisfy the criteria (i.e., the user is looking at the touch device), then voice input or voice commands may be selectively received and processed via the touch device. As a technical effect, the voice commands are processed by a single device rather than the devices competing to generate a response to the same voice command.

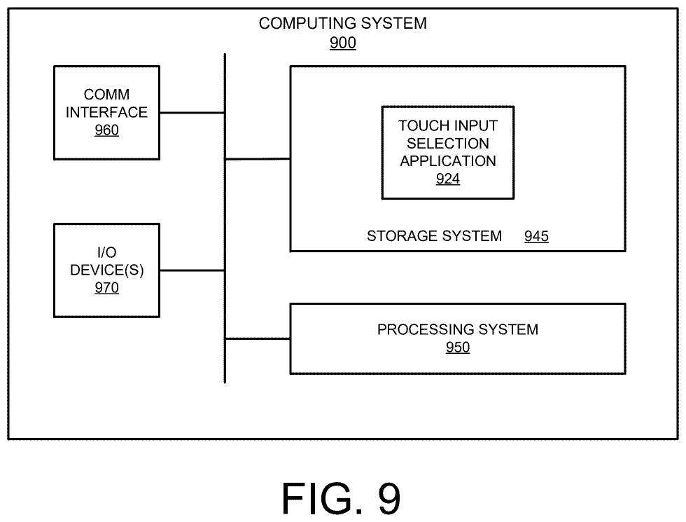

FIG. 9 illustrates a computing system 900 to manage assignment of touch input from a touch device according to an implementation. Computing system 900 is representative of any computing system or systems with which the various operational architectures, processes, scenarios, and sequences disclosed herein for assigning touch inputs to different devices may be implemented. Computing system 900 is an example of an XR device, a touch device, or a combination of an XR device and touch device as described herein. Computing system 900 includes storage system 945, processing system 950, communication interface 960, input/output (I/O) device(s) 970. Processing system 950 is operatively linked to communication interface 960, I/O device(s) 970, and storage system 945. Communication interface 960 and/or I/O device(s) 970 may be communicatively linked to storage system 945 in some implementations. Computing system 900 may further include other components such as a battery and enclosure that are not shown for clarity.

Communication interface 960 comprises components that communicate over communication links, such as network cards, ports, radio frequency, processing circuitry and software, or some other communication devices. Communication interface 960 may be configured to communicate over metallic, wireless, or optical links. Communication interface 960 may be configured to use Time Division Multiplex (TDM), Internet Protocol (IP), Ethernet, optical networking, wireless protocols, communication signaling, or some other communication format-including combinations thereof. Communication interface 960 may be configured to communicate with external devices, such as servers, user devices, or some other computing device.

I/O device(s) 970 may include peripherals of a computer that facilitate the interaction between the user and computing system 900. Examples of I/O device(s) 970 may include keyboards, mice, trackpads, monitors, displays, printers, cameras, microphones, external storage devices, sensors, and the like.

Processing system 950 comprises microprocessor circuitry (e.g., at least one processor) and other circuitry that retrieves and executes operating software (i.e., program instructions) from storage system 945. Storage system 945 may include volatile and nonvolatile, removable, and non-removable media implemented in any method or technology for storage of information, such as computer readable instructions, data structures, program modules, or other data. Storage system 945 may be implemented as a single storage device but may also be implemented across multiple storage devices or sub-systems. Storage system 945 may comprise additional elements, such as a controller to read operating software from the storage systems. Examples of storage media (also referred to as computer readable storage media) include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 950 is typically mounted on a circuit board that may also hold the storage system. The operating software of storage system 945 comprises computer programs, firmware, or some other form of machine-readable program instructions. The operating software of storage system 945 comprises touch input selection application 924. The operating software on storage system 945 may further include an operating system, utilities, drivers, network interfaces, applications, or some other type of software. When read and executed by processing system 950 the operating software on storage system 945 directs computing system 900 to operate as a computing device as described herein. In at least one implementation, the operating software can provide method 200 described in FIG. 2, method 600 described in FIG. 6, or method 800 described in FIG. 8 as well as any other operation to assign touch input from a touch device to another device based on orientation of the devices.

In at least one example, touch input selection application 924 directs processing system 950 to identify an orientation of a first device (e.g., touch device) relative to a second device (e.g., XR device) and determine whether the orientation satisfies at least one criterion. Touch input selection application 924 further directs processing system 950 to, in response to the orientation satisfying the at least one criterion, receive touch input for the second device from the first device. Alternatively, touch input selection application 924 directs processing system to, in response to the orientation not satisfying the at least one criterion, receive touch input for the first device from the first device.

In at least one implementation, computing system 900 identifies the orientation of the first device to the second device using orientation vectors associated with each of the devices. For example, sensors on the first device will determine a first orientation vector and sensors on the second device will determine a second orientation vector. The vectors are then combined into an angle and compared to a threshold to determine whether the user is viewing the first device (i.e., touch device). When the user is viewing the touch device, input for the touch device is directed to the touch device. Alternatively, when the user is not viewing the touch device (angle exceeds the threshold), then touch input at the touch device is directed to the second device (XR device). Advantageously,

In at least one implementation, computing system 900 identifies the orientation of the first device relative to the second device based on image data and eye gaze information from the second device. The image data and gaze information may be used to determine whether the gaze of the user of the second device (XR device) is actively viewing the first device (touch device). In at least one implementation, the image data and gaze information may be used to determine an orientation angle of the gaze in relation to the orientation of the touch device. The angle is then compared to a threshold to determine where to assign touch input from the touch device. When viewing the touch device, touch input at the touch device is directed to the touch device. When looking away from the touch device, touch input on the touch device may be assigned to the XR device and communicated to the XR device using a wireless communication protocol. This permits the touch device to function as an input device for multiple devices based on the orientations of the different devices.

In at least one implementation, computing system 900 identifies the orientation of the first device relative to the second device based on image data from the first device. For example, the first device may represent a smartphone or some other touch device with a front facing camera capable of capturing the gaze of a user (e.g., user of the second device or XR device). From the gaze information, computing system 900 may determine whether the user is viewing the touch device or looking away from the touch device.

Clause 1. A method comprising: identifying an orientation of a first device relative to a second device; determining whether the orientation satisfies at least one criterion; in response to the orientation satisfying the at least one criterion, receiving touch input for the second device from the first device; and in response to the orientation not satisfying the at least one criterion, receiving touch input for the first device from the first device.

Clause 2. The method of clause 1, wherein identifying the orientation of the first device relative to the second device comprises: identifying a first vector associated with a first orientation for the first device; identifying a second vector associated with a second orientation for the second device; identifying an angle between the first vector and the second vector; and identifying the angle as the orientation of the first device relative to the second device.

Clause 3. The method of clause 2, wherein determining whether the orientation satisfies the at least one criterion comprises: determining whether the angle exceeds a threshold, the first vector being a first direction of a screen associated with the first device, and the second vector being a second direction of a gaze associated with the second device.

Clause 4. The method of clause 2, wherein identifying the first vector comprises identifying the first vector based on a measurement from at least one of an accelerometer or a gyroscope on the first device, the first vector being a direction of a screen associated with the first device.

Clause 5. The method of clause 2, wherein identifying the second vector comprises identifying the second vector based on a measurement from at least one of an accelerometer or a gyroscope on the second device, the second vector being a direction of a gaze associated with the second device.

Clause 6. The method of clause 1, wherein identifying the orientation of the first device relative to the second device comprises: identifying a gaze associated with a user of the second device; identifying image data from the second device; and identifying the orientation of the first device relative to the second device based on the gaze and the image data.

Clause 7. The method of clause 1, wherein identifying the orientation of the first device relative to the second device comprises: identifying image data on from the first device; identifying a gaze of a user of the second device based on the image data; and identifying the orientation of the first device relative to the second device based at least on the gaze.

Clause 8. The method of clause 1 further comprising: receiving a notification; in response to the orientation satisfying the at least one criterion, causing display of the notification on the second device; and in response to the orientation not satisfying the at least one criterion, causing display of the notification on the first device.

Clause 9. The method of clause 1, wherein: the first device comprises a companion device; and the second device comprises an XR device in communication with the companion device.

Clause 10. A computer-readable storage medium storing program instructions that when executed by at least one processor cause the at least one processor to execute operations, the operations comprising: identifying an orientation of a first device relative to a second device; determining whether the orientation satisfies at least one criterion; in response to the orientation satisfying the at least one criterion, receiving touch input for the second device from the first device; and in response to the orientation not satisfying the at least one criterion, receiving touch input for the first device from the first device.

Clause 11. The computer-readable storage medium of clause 10, wherein identifying the orientation of the first device relative to the second device comprises: identifying a first vector associated with a first orientation for the first device; identifying a second vector associated with a second orientation for the second device; identifying an angle between the first vector and the second vector; and identifying the angle as the orientation of the first device relative to the second device.

Clause 12. The computer-readable storage medium of clause 11, wherein determining whether the orientation satisfies the at least one criterion comprises: determining whether the angle exceeds a threshold, the first vector being a first direction of a screen associated with the first device, and the second vector being a second direction of a gaze associated with the second device.

Clause 13. The computer-readable storage medium of clause 11, wherein identifying the first vector comprises identifying the first vector based on a measurement from at least one of an accelerometer or a gyroscope on the first device, the first vector being a direction of a screen associated with the first device.

Clause 14. The computer-readable storage medium of clause 11, wherein identifying the second vector comprises identifying the second vector based on a measurement from at least one of an accelerometer or a gyroscope on the second device, the second vector being a direction of a gaze associated with the second device.

Clause 15. The computer-readable storage medium of clause 10, wherein identifying the orientation of the first device relative to the second device comprises: identifying a gaze associated with a user of the second device; identifying image data from the second device; and identifying the orientation of the first device relative to the second device based on the gaze and the image data.

Clause 16. The computer-readable storage medium of clause 10, wherein identifying the orientation of the first device relative to the second device comprises: identifying image data on from the first device; identifying a gaze of a user of the second device from the image data; and identifying the orientation of the first device relative to the second device based at least on the gaze.

Clause 17. An apparatus comprising: at least one processor; and a computer-readable storage medium storing program instructions that cause the at least one processor to: identify an orientation of a first device relative to a second device; determine whether the orientation satisfies at least one criterion; in response to the orientation satisfying the at least one criterion, receive touch input for the second device from the first device; and in response to the orientation not satisfying the at least one criterion, receive touch input for the first device from the first device.

Clause 18. The apparatus of clause 17, wherein identifying the orientation of the first device relative to the second device comprises: identifying a first vector associated with a first orientation for the first device; identifying a second vector associated with a second orientation for the second device; identifying an angle between the first vector and the second vector; and identifying the angle as the orientation of the first device relative to the second device.

Clause 19. The apparatus of clause 18, wherein determining whether the orientation satisfies the at least one criterion comprises: determining whether the angle exceeds a threshold, the first vector being a first direction of a screen associated with the first device, and the second vector being a second direction of a gaze associated with the second device.

Clause 20. The apparatus of clause 17, wherein identifying the orientation of the first device relative to the second device comprises: identifying a gaze associated with a user of the second device; identifying image data from the second device; and identifying the orientation of the first device relative to the second device based on the gaze and the image data.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that the terminology employed herein is for the purpose of describing aspects and is not intended to be limiting. On the contrary, this patent covers all methods, apparatus and articles of manufacture fairly falling within the scope of the claims of this patent.

1. A method comprising:
identifying an orientation of a first device relative to a second device based on a gaze of a user of the second device;
determining whether the orientation satisfies at least one criterion;
in response to the orientation satisfying the at least one criterion, receiving touch input for the second device from the first device; and
in response to the orientation not satisfying the at least one criterion, receiving touch input for the first device from the first device.

2. The method of claim 1, wherein identifying the orientation of the first device relative to the second device comprises:
identifying a first vector associated with a first orientation for the first device;
identifying a second vector associated with a second orientation for the second device;
identifying an angle between the first vector and the second vector; and
identifying the angle as the orientation of the first device relative to the second device.

3. The method of claim 2, wherein determining whether the orientation satisfies the at least one criterion comprises:
determining whether the angle exceeds a threshold, the first vector being a first direction of a screen associated with the first device, and the second vector being a second direction of the gaze.

4. The method of claim 2, wherein identifying the first vector comprises identifying the first vector based on a measurement from at least one of an accelerometer or a gyroscope on the first device, the first vector being a direction of a screen associated with the first device.

5. The method of claim 2, wherein identifying the second vector comprises identifying the second vector based on a measurement from at least one of an accelerometer or a gyroscope on the second device, the second vector being a direction of the gaze.

6. The method of claim 1, wherein identifying the orientation of the first device relative to the second device comprises:
identifying image data from the second device; and
identifying the orientation of the first device relative to the second device based on the gaze and the image data.

7. The method of claim 1, further comprising:
identifying image data from the first device; and
determining the gaze of the user of the second device based on the image data.

8. The method of claim 1 further comprising:
receiving a notification;
in response to the orientation satisfying the at least one criterion, causing display of the notification on the second device; and
in response to the orientation not satisfying the at least one criterion, causing display of the notification on the first device.

9. The method of claim 1, wherein:
the first device comprises a companion device; and
the second device comprises an XR device in communication with the companion device.

10. A non-transitory computer-readable storage medium storing program instructions that when executed by at least one processor cause the at least one processor to execute operations, the operations comprising:
identifying an orientation of a first device relative to a second device based on a gaze of a user of the second device;
determining whether the orientation satisfies at least one criterion;
in response to the orientation satisfying the at least one criterion, receiving touch input for the second device from the first device; and
in response to the orientation not satisfying the at least one criterion, receiving touch input for the first device from the first device.

11. The non-transitory computer-readable storage medium of claim 10, wherein identifying the orientation of the first device relative to the second device comprises:
identifying a first vector associated with a first orientation for the first device based on a gaze of a user of the second device;
identifying a second vector associated with a second orientation for the second device;
identifying an angle between the first vector and the second vector; and
identifying the angle as the orientation of the first device relative to the second device.

12. The non-transitory computer-readable storage medium of claim 11, wherein determining whether the orientation satisfies the at least one criterion comprises:
determining whether the angle exceeds a threshold, the first vector being a first direction of a screen associated with the first device, and the second vector being a second direction of the gaze.

13. The non-transitory computer-readable storage medium of claim 11, wherein identifying the first vector comprises identifying the first vector based on a measurement from at least one of an accelerometer or a gyroscope on the first device, the first vector being a direction of a screen associated with the first device.

14. The non-transitory computer-readable storage medium of claim 11, wherein identifying the second vector comprises identifying the second vector based on a measurement from at least one of an accelerometer or a gyroscope on the second device, the second vector being a direction of the gaze.

15. The non-transitory computer-readable storage medium of claim 10, wherein identifying the orientation of the first device relative to the second device comprises:
identifying image data from the second device; and
identifying the orientation of the first device relative to the second device based on the gaze and the image data.

16. The non-transitory computer-readable storage medium of claim 10, wherein the operations further comprise:
identifying image data from the first device; and
determining the gaze of the user of the second device from the image data.

17. An apparatus comprising:
at least one processor; and
a non-transitory computer-readable storage medium storing program instructions that cause the at least one processor to:
identify an orientation of a first device relative to a second device based on a gaze of a user of the second device;
determine whether the orientation satisfies at least one criterion;
in response to the orientation satisfying the at least one criterion, receive touch input for the second device from the first device; and
in response to the orientation not satisfying the at least one criterion, receive touch input for the first device from the first device.

18. The apparatus of claim 17, wherein identifying the orientation of the first device relative to the second device comprises:
identifying a first vector associated with a first orientation for the first device;
identifying a second vector associated with a second orientation for the second device;
identifying an angle between the first vector and the second vector; and
identifying the angle as the orientation of the first device relative to the second device.

19. The apparatus of claim 18, wherein determining whether the orientation satisfies the at least one criterion comprises:
determining whether the angle exceeds a threshold, the first vector being a first direction of a screen associated with the first device, and the second vector being a second direction of the gaze.

20. The apparatus of claim 17, wherein identifying the orientation of the first device relative to the second device comprises:
identifying image data from the second device; and
identifying the orientation of the first device relative to the second device based on the gaze and the image data.
